(19) United States
(12) Patent Application Publication
(10) Pub. No.: US 2008/0054868 A1
(43) Pub. Date: Mar. 6, 2008

(54) Pseudo average current mode control scheme for switching power converters

(76) Inventor: Qi Cui Wei, Cupertino, CA (US)

Correspondence Address: Qi Cui Wei, 21900 Rucker Dr., Cupertino, CA, 95014, US

(21) Appl. No.: 11/818,940

(22) Filed: Jun. 18, 2007

(30) Foreign Application Priority Data
Aug. 29, 2006 (CN) 200610053195.1

(51) Int. Cl. G05F 1/10

(52) U.S. Cl. 323/282

(57) ABSTRACT

A Pseudo Average Output Current Control scheme is provided. The control scheme allows only detecting one part of the inductor current of the switching converter to control the average output current of the switching converter follow the reference current. The control scheme is noise insensitive and makes the whole controlled system cost effective.

### BACKGROUND OF THE INVENTION

The present invention relates to switching converter using several topologies. More particularly, the invention relates to a new control scheme to control the output current of the switching converter, and the switching converter can be used as a controllable current source for several applications.

In existed switching converter control schemes, there are several control methods. They can be classified as voltage mode control and current mode control. In order to simply implement, the peak current mode plus voltage loop has been widely used in switching power supply application. In the peak current mode plus voltage loop control scheme of the switching power supply, only part of the inductor current information is detected to adjust the equivalent current source. With the regulation of the voltage loop, the switching power supply can have a very proficient line and load performance.

The average output current control is particularly useful in applications such as controllable current source, e.g. battery charger and LED driver. In this kind of application, there is no a fast response voltage loop to adjust the output current due to a variable load. To make good average output current regulation, it needs average output current control scheme.

To implement the average output current control, it is required to collect all information of the inductor and output currents. In an online application, the requirement to collect all current information is easier to satisfy. In an off line application, it will be much tougher due to an isolation requirement issue. The question from the application is whether there is a control scheme for converter only to detect a part of the converter's inductor current information to make the control performance much closer to the average output current control performance. The present invention is to present a control scheme that can detect only a part of the inductor current and make the control performance much closer to the average output current control performance; that is, a very proficient line and load regulation.

### SUMMARY OF THE INVENTION

The present invention discloses a novel “Pseudo Average Output Current Control” scheme to control a switching converter and make the average output current of the switching converter follow a reference current. This way, the output of the switching converter is a current source for several applications.

The control scheme of “Pseudo Average Output Current Control” is composed of several blocks. The reference block converts the reference signal into a suitable format; In reference calculation block, for different power topologies, step up, step down and step up and down converters, the correspondent algorithm is calculated to convert the input reference into correspondent output; In state detecting block, the states of switching power converter are detected and the detected signals are converted into the same signal format as one of output from reference block; The error generator is used to detect the error between the outputs from reference calculated block and state detected block; the error amplifier is used to amplify and compensate the error and generate the PWM modulated signal; PWM generator converts the modulated signal into a series of PWM pulses.

The reference block can be simple as comprising of a switch and be implemented with several operation functions.

Based on correspondent switching converter topology, the reference calculated block has related algorithm and the algorithm may be simple as a fixed gain and be implemented with several operation functions.

The state detect block can be simple as a sense resistor and be implemented with several operation functions.

The error generator can be simple as summer and be complete with several operation functions. The error generator can be combined with the error amplifier.

The output of PWM modulator is used to synchronize reference block, reference calculated block and state detect block.

In reference and reference calculated blocks, the reference signals are traded in the same format as one of the states in the system state detect block.

The invented control scheme uses all information in a part of the inductor current, including slew rate, valley and peak values and instant average current. The easiest way to detect part of the inductor current is to detect the power switching current. The invented control scheme is composed of several function blocks. As shown in FIG. 1, they are reference block, reference calculated block, state detecting block, error generator, error amplifier and PWM generator.

In order to compare the reference current and the average output current, only the power switch turn-on current is detected as a part of the inductor current and the power switch turn-off current is zero, so the reference current should be traded in a suitable format in order to compare with the power switch turn-on current. In the reference block, the reference current is generated as in a suitable format. At the same time, in the state detect block, the detected power switch current is generated in the same format of the reference current. It is clear that during the power switch turn-on time, the instantaneous reference and the power switch's detected current can be detected. During the power switch turn-off time, both the reference current and power switch current are zero.

In the reference calculation block, based on different power topologies, step up, step down and step up and down converters, the output of reference block is calculated in preset algorithm to generate the correspondent control for the power topology. As power switch turn-off t, both the correspondent control signal and power switch current are zero.

In the error generator, the error between the output of reference calculation block and power switch current is detected.

In the error amplifier block, the error is amplified, sample-held, or accumulated. The output error can be much closer to the difference between the reference current and the average output current. The error can be amplified and compensated and generated as a series of PWM pulses in a PWM generator. Due to the converter's regulation loop, the error can be minimized and the average output current can be followed with the reference current.

### BRIEF DESCRIPTION OF THE DRAWINGS

FIG. 1 is a general “Pseudo Average Output Current Control” scheme block diagram of the present invention;

FIG. 2 is one of detailed embodiment of the “Pseudo Average Output Current Control” scheme block diagram of the present invention;

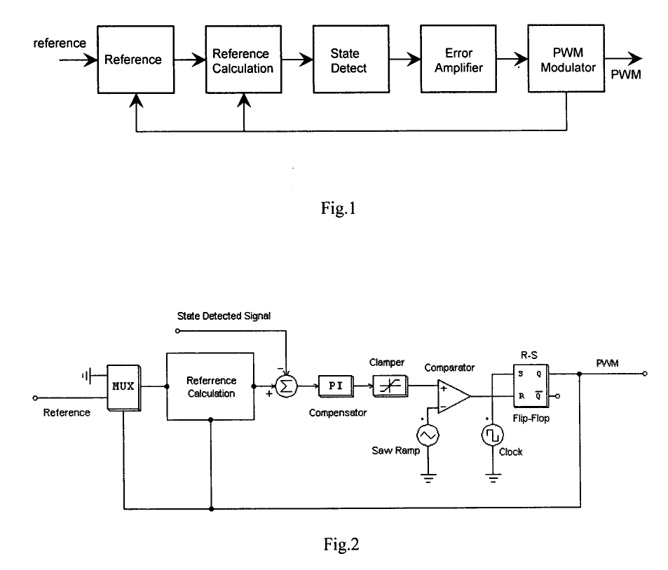

### DETAIL DESCRIPTION OF THE INVENTION

FIG. 2 shows one detailed embodiment of invention scheme block diagram. In the detailed block diagram, there are several blocks: MUX reference block, reference calculated block, summer, PID compensator, LIM clamper, comparator, R-S flip-flop, Saw ramp and a time clock Fs.

The time clock is used to set up the switching frequency and synchronize several reset functions in each required block. The ramp of the PWM generator is generated from the time clock Fs and a simple circuit. It can be in a triangle or saw waveform.

The reference signal, or reference current, is chopped with a MUX and then as an input to the reference calculated block. At the same time, the state variable of the switching converter, or the inductor current, is detected through the power switch and as an input to one of the summer's input.

Based on the switching converter topology, the reference calculated block has related algorithm and outputs the correspondent control signal. The output signal is used as another input of the summer.

It is clear that both inputs of summer have correspondent amplitudes when the PWM pulse is at high level “1” and both inputs are at zero when the PWM pulse is at the low level of “0” also.

Two inputs are subtracted in the summer to generate the error that is much closer to the differential difference between the reference current and average output current. As the PWM pulse is at low level “0”, due to both inputs of summer low, the output of summer is zero too.

K The output of summer is used as the input of PID compensator. After integrating through PID compensator, the output of PID compensator is the deference between the reference current and the average output current. The difference is amplified and compensated as PWM modulated signal. Due to the converter's regulation loop, the error can be compensated and ignored.

PWM modulator is composed of LIM clamper, comparator, R-S flip flop, saw waveform and clock Fs. The output modulated signal from PID compensator generates a series PWM pulses through PWM generator.

A series of PWM output pluses from PWM generator control the power switch of the switching converter and make the output average current of the switching converter follow with the reference variation.

To apply to the control scheme, the easiest way is to detect the power switch current. The power switch can be the main power switch or any other power switch, e.g. freewheel diode for buck, boost, and buck-boost basic circuits. As long as the inductor current passes through the power device and the power device's current can be detected, the power device's current can be represented as a part of the inductor current.

The benefit of using “Pseudo Average Output Current Control” technology is that it is the simplest and lowest cost detecting way to implement the equivalent average current mode control performance. Due to the integration function in the control scheme, the control scheme is insensitive with noise. It is very easy and helpful for a switching converter PCB layout.

What is claimed is:

1. Pseudo Average Output Current Control scheme comprising:
Reference block for converting the regular reference signal to a suitable format signal; and
Reference calculation block, for different power topologies, step up, step down and step up and down converters, with the correspondent algorithm for converting the input reference into correspondent output; and
State detect block for detecting the state of the switching converter and converting the detected signal to the same format in the reference block: and
Error generator for detecting the difference between two signals from the reference calculated block and the state detect block; and
Error amplifier for amplifying and compensating the error signal from the error generator and generating a modulation signal for PWM generator; and
PWM generator for converting the modulation signal to a series of PWM pulses.

2. Pseudo Average Output Current Control scheme claim 1, wherein the reference block can be simple as comprising of a switch and be implemented with several operation functions.

3. Pseudo Average Output Current Control scheme claim 1, wherein the reference calculated block can be simple as comprising of a fixed gain or be implemented with several operation functions.

4. Pseudo Average Output Current Control scheme claim 1, wherein the state detect block can be simple as a sense resistor and be implemented with several operation functions.

5. Pseudo Average Output Current Control scheme claim 1, wherein the error generator can be simple as summer and be complete with several operation functions.

6. Pseudo Average Output Current Control scheme claim 1, wherein the error generator can be combined with the error amplifier.

7. The output of PWM generator is used to synchronize reference block, reference calculated block, state detect block and or error generator.

8. Reference block and reference calculated block treat their input signals in the same way in which state detect block treats its input in operation and time interval.
